(19) United States
(12) Patent Application Publication
(10) Pub. No.: US 2026/0114476 A1
(43) Pub. Date: Apr. 30, 2026

(54) FREEZABLE CHUM SPHERE

(71) Applicant: Cesar Oneid, Palm Beach Gardens, FL (US)

(72) Inventor: Cesar Oneid, Palm Beach Gardens, FL (US)

(21) Appl. No.: 19/010,851

(22) Filed: Jan. 6, 2025

Related U.S. Application Data
(63) Continuation-in-part of application No. 18/928,029, filed on Oct. 27, 2024, now abandoned.

(51) Int. Cl. A23K 50/80; A23K 10/22; A23K 10/30; A23K 20/20; A23K 40/20

(52) U.S. Cl. CPC A23K 50/80; A23K 10/22; A23K 10/30; A23K 20/20; A23K 40/20

(57) ABSTRACT

The present invention provides a freezable chum sphere designed to improve fishing efficiency in attracting marine species by ensuring controlled dispersal of chum to attract fish throughout the water column. The sphere includes chum as the primary attractant, negatively buoyant material for weight, a bulk enhancer for texture and uniform mixing, and honey as a natural binder. The honey enables the sphere to maintain structural integrity when frozen and facilitates gradual breakdown upon contact with water, allowing for even distribution of the bait. Optional additives, such as edible glitter and powdered fish or shrimp extracts, enhance visual appeal and scent targeting. The sphere is molded into a durable form for ease of freezing, storage, transport, and deployment, offering an environmentally friendly and practical solution for anglers.

### PRIORITY CLAIM

In accordance with 37 C.F.R. 1.76, a claim of priority is included in an Application Data Sheet filed concurrently herewith. Accordingly, the present invention claims priority as a continuation-in-part of U.S. patent application Ser. No. 18/928,029, entitled “ENHANCED FREEZABLE CHUM SPHERE FOR IMPROVED FISHING AND PRODUCTION EFFICIENCY”, filed Oct. 27, 2024. The contents of the above referenced application are incorporated herein by reference in its entirety.

### FIELD OF THE INVENTION

The present invention s generally to fishing equipment designed to improve bait dispersal and fishing efficiency to attract marine species. More specifically, the present invention relates to a freezable chum sphere that maintains structural integrity during transport and evenly disperses its components in water to attract fish at multiple depths.

### BACKGROUND OF THE INVENTION

Fishing has been a vital activity for both sustenance and recreation for centuries. Over time, techniques evolved to improve fishing and its effectiveness. A key aspect of fishing is attracting fish to the desired location, often achieved by using bait or chum. Traditional fishing methods employ loose chum, which is dispersed manually or with specialized equipment to draw fish to a specific area. While effective in the short term, these methods often suffer from uneven distribution and rapid dispersal, and thus reducing their ability to consistently attract fish over extended periods or at various depths.

Existing chum products and methods typically lack a mechanism for controlled and prolonged release. Many rely on synthetic or complex binders to hold the mixture together, which may impede natural dispersal or break apart too quickly. Inconsistent dispersal not only diminishes the effectiveness of the chum but also necessitates frequent replenishment, which in turn increases both cost and labor for anglers. Additionally, certain methods require the use of external tools such as chum bags, which may be cumbersome to use, especially in dynamic marine environments.

The limitations of traditional chum products also extend to their practicality for storage and transport. Loose or poorly bound chum mixtures often lose structural integrity when exposed to moisture or freezing, making them difficult to handle and store. Freezing, a common preservation method for fishing bait, can cause brittleness or degradation in conventional chum mixtures, causing major issues with the transportation and storage of the chum itself. Transporting these mixtures can also be problematic as they may leak, crumble, or lose shape during handling.

Fishing enthusiasts and professionals alike face challenges with traditional chum products. These challenges include inefficient dispersion and lack of durability needed for freezing and transport. Many rely on artificial binders, which can potentially be harmful to aquatic ecosystems. The result is a product that is neither effective nor sustainable for repeated use. What is needed in the industry is a chum solution that combines natural, eco-friendly ingredients with practical design to improve fishing and production efficiency.

### SUMMARY OF THE INVENTION

The present invention includes a type of fish bait in the form of a freezable chum sphere designed to address the limitations of traditional chum products. This invention incorporates natural, eco-friendly binders and a spherical structure to ensure consistent dispersal of chum components throughout the water column. The sphere is formulated with a predetermined amount of chum as the primary attractant, negatively buoyant material for weight, a bulk enhancer for uniform mixing and gradual dispersal in water, and a predetermined amount of honey as a natural binder. Honey's unique hygroscopic properties allow the sphere to maintain 1 integrity when frozen and gradually disperse its contents upon contact with water.

The freezable chum sphere offers practical advantages in storage, transport, and deployment. The chum sphere is molded into a durable shape by mixing the composition and placing it into a 3D-printed PETG mold. The mold is designed to give the composition a spherical shape to ensure that they retain their structure during freezing and transport. Using such a mold eliminates the need for cumbersome tools or additional equipment. Optional additives, such as edible glitter for visual attraction or powdered fish and shrimp extracts for species-specific targeting, may be added to improve the chum sphere's versatility.

The present invention addresses the limitations of traditional chum methods by incorporating natural, biodegradable materials, such as honey, into the spherical structure. Its composition ensures controlled and gradual dispersal of bait throughout the water column. Utilizing eco-friendly binders such as honey and providing a durable form suitable for freezing and transport, the present invention offers a practical and environmentally responsible solution for anglers.

An objective of the present invention is to provide a freezable chum product that ensures gradual and controlled dispersal in water for improved fishing efficiency in attracting marine species across multiple depths.

Another objective of the present invention is to utilize eco-friendly and biodegradable materials, such as honey, to promote environmental sustainability by acting as a natural binder while maintaining the structural integrity of the chum sphere.

Yet another objective of the present invention is to simplify the storage and transport of chum by offering a durable, moldable product that retains its shape and effectiveness during freezing and handling.

A further objective of the present invention is to enhance the versatility of the chum sphere through the inclusion of optional additives, such as edible glitter and powdered attractants, for targeting specific fish species or increasing visual appeal.

It will also be appreciated that various combinations of the features disclosed hereafter for a freezable chum sphere are also possible as desired.

### BRIEF DESCRIPTION OF THE FIGURES

The present invention is illustrated and described herein with reference to the various drawings, in which like reference numbers are used to denote like system components/method steps, as appropriate, and in which:

FIG. 1 is a flow diagram of a method of manufacturing a freezable chum sphere.

### DETAILED DESCRIPTION OF THE INVENTION

While the present invention is susceptible of embodiment in various forms, there is shown in the drawings and will hereafter be described a presently preferred, albeit not limiting, embodiment with the understanding that the present disclosure is to be considered an exemplification of the present invention and is not intended to limit the invention to the specific embodiments illustrated.

The present invention pertains to a freezable chum sphere designed to improve fishing efficiency in attracting marine species by addressing the limitations of traditional chum methods. The invention provides a durable, easy-to-use, and environmentally friendly alternative that ensures gradual dispersal of chum in the water column to attract fish at various depths.

Chum, the primary component of the invention, serves as the attractant to draw marine species. Common ingredients used to form chum include fish byproducts such as ground fish parts (e.g., heads, guts, and tails) or fishmeal, which create a robust scent trail. Additional sources of chum include baitfish, such as sardines, mackerel, and anchovies, which are typically chopped or ground to increase dispersal of the fish attractant. Shellfish remains, shrimp heads, and crab shells can also be added to vary the scent profile and attract specific species.

To further intensify the scent trail, an amount of strong-smelling ingredients such as fish blood or animal offal may be included. These components release potent olfactory signals which make the chum sphere more effective in drawing fish from significant distances. The addition of bulk enhancers, wherein the bulk enhancer is oats, flour, cornmeal, or wheat, provides texture and uniform mixing. The bulk enhancer helps hold the mixture together which allows the chum to be formed into a spherical shape. Honey, a natural binder, is added to the composition, which is essential for maintaining the sphere's integrity during freezing and transport. Additionally, the bulk enhancer itself can include honey.

The chum sphere is carefully constructed to ensure consistent and gradual dispersal of its components. Negatively buoyant material is used in a predetermined amount to ensure the chum sphere sinks into the water column. Sand having a micron rating between 100 and 1000 microns in an amount sufficient to sink the chum in salt water is incorporated to add weight and is the primary negatively buoyant material used in the chum sphere. The increased weight ensures the sphere sinks effectively in aquatic environments. In a preferred embodiment, 33% of the freezable chum sphere's composition is due to a negatively buoyant material such as sand. The amount of negatively buoyant material or sand included in the composition of the chum sphere, however, is not limiting. Additionally, other negatively buoyant materials may be used in a predetermined amount such as grain grit, sediment, gravel, sinking pellets, crushed shells, or aquatic plant-based feed.

A natural honey binder is used not only to keep the ingredients compact during freezing and storage, but it also gradually dissolves in water. This dissolving process, facilitated by osmotic diffusion, allows the controlled release of the embedded attractants over time. The gradual dispersal enhances the sphere's ability to attract fish at various depths.

Optional additives, such as edible glitter, may be included to enhance visual attraction by creating a sparkling effect underwater. To minimize environmental impact, the glitter is biodegradable. Powdered fish or shrimp extracts can also be added to intensify the scent profile, catering to specific fishing conditions or targeted marine species.

The term “predetermined amount,” as used herein, refers to a quantity of a given component that is selected based on specific factors to achieve the intended function of the chum sphere. The predetermined amount for each component is selected to balance the sphere's physical properties such as its ability to sink in saltwater, maintain structural integrity during freezing and storage, and gradually release attractants to optimize effectiveness in attracting marine species.

For example, the predetermined amount of chum is selected based on the desired strength of the attractant effect and may range from about 20% to 50% of the total weight of the chum sphere. The exact amount may vary depending on the target marine species and environmental conditions.

The predetermined amount of negatively buoyant material is chosen to ensure that the chum sphere sinks in saltwater while maintaining an appropriate release rate. This amount may range from about 10% to 40% of the total weight of the chum sphere.

The predetermined amount of bulk enhancer is selected to provide sufficient structure for uniform mixing and to facilitate gradual dispersal. This may range from about 10% to 25% of the total weight of the chum sphere.

The predetermined amount of honey is used as a binder to maintain the spherical shape during freezing and storage, as well as to contribute to the gradual release of the chum. The honey may range from about 5% to 15% of the total weight of the chum sphere.

These ranges are exemplary and not limiting. A person of ordinary skill in the art may determine the precise amounts of each component based on empirical testing, intended use, and specific environmental conditions, such as water salinity, temperature, and depth.

An exemplary example composition of the freezable chum sphere includes approximately 33% chum, 33% sand, 20% oats, and 10-15% honey, with the remaining portion including optional visual attractants, such as the edible glitter. This formulation is illustrative and not limiting, as variations in ingredient proportions or the inclusion of additional components may be made to suit specific fishing environments or target species.

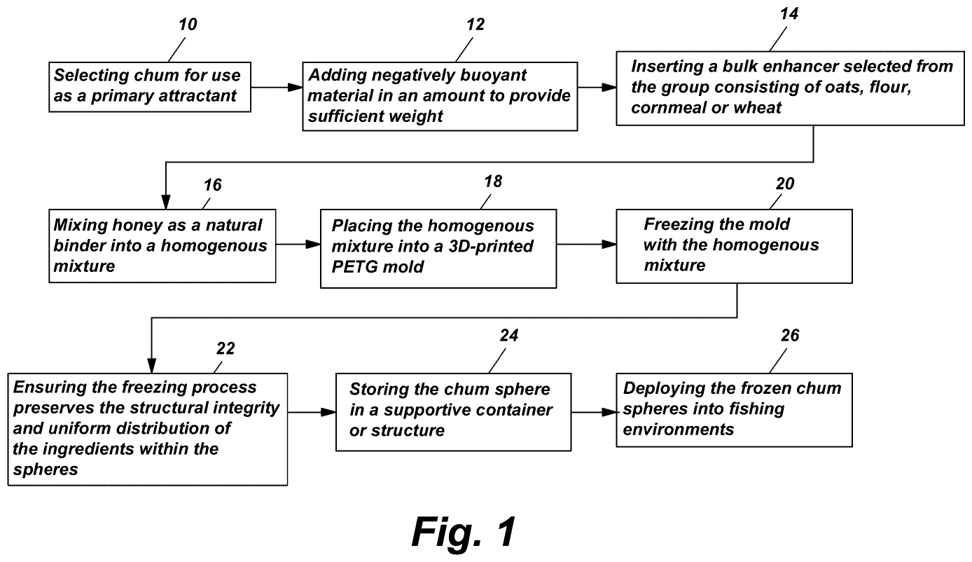

Referring now to FIG. 1, the production of the freezable chum sphere begins with selecting chum as the primary attractant for marine species 10, ensuring the chum is dispersible in water. In a preferred embodiment, a predetermined amount of chum is selected from a group consisting of ground fish parts, fishmeal, sardines, mackerel or anchovies. The chum sphere may also include shellfish remains, shrimp heads, or crab shells to add a scent trail. In an alternative embodiment, an amount of fish blood or animal offal may be used to create a scent trail.

Sand having a micron rating between 100 and 1000 or other negatively buoyant materials in a predetermined amount such as grain grit, sediment, gravel, sinking pellets, crushed shells, or aquatic plant-based feed is then added in an appropriate amount 12 to provide sufficient weight which enables the chum sphere to sink effectively in aquatic environments, particularly in salt water environments. A bulk enhancer, which is selected from the group consisting of oats, flour, cornmeal, or wheat, is then inserted 14 to facilitate uniform mixing and support gradual dispersal. Next, honey is mixed into the formulation as a natural binder in a quantity sufficient to create a homogenous mixture 16 that maintains the structural integrity of the chum sphere during freezing and storage. The honey also ensures a gradual release of the embedded attractants when the sphere is submerged in water.

The resulting homogeneous mixture is placed into molds 18, such as 3D-printed PETG molds, which are designed to form the homogenous mixture into a sphere and allow for easy removal of the frozen spheres without damage. In a preferred embodiment, the molds form the homogenous mixture into 3-inch diameter spheres. The homogenous mixture within the molds is frozen 20 to preserve the structural integrity and ensure uniform distribution of the ingredients throughout each sphere 22. Once frozen, the spheres are stored in a supportive container or structure 24, such as a paper, plastic, or foam mold, which maintains the spherical shape and protects the structural integrity of the chum spheres during transport and handling until use.

The frozen chum spheres are deployed into fishing environments 26, where they gradually dissolve as the honey binder interacts with the surrounding water. This controlled dissolution releases the embedded attractants over time, optimizing the effectiveness of the chum in attracting marine species. The sand within the sphere ensures steady sinking which allows the chum to disperse evenly through the water column and attract fish at various depths.

The freezable chum sphere prioritizes sustainability by incorporating natural and biodegradable ingredients. The use of honey as a natural binder reduces reliance on synthetic materials. Additionally, biodegradable additives such as edible glitter ensure minimal ecological impact while enhancing the effectiveness of the chum sphere.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements, possesses those one or more steps or elements, but is not limited to possessing only those one or more elements. Likewise, a step of a method or an element of a device that “comprises,” “has,” “includes,” or “contains” one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated it is not to be limited to the specific form or arrangement herein described and shown. It will be apparent to those skilled in the art that various changes may be made without departing from the scope of the invention, and the invention is not to be considered limited to what is shown and described in the specification and any drawings/FIGURES included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to specific such embodiments. Indeed, various modifications of the described modes for carrying out the invention which are obvious to those skilled in the art are intended to be within the scope of the following claims.

What is claimed is:

1. A freezable chum sphere configured for use in attracting marine species, the chum sphere comprising:
a predetermined amount of chum selected from the group consisting of fish byproducts namely ground fish parts or fishmeal, said chum used as a primary attractant for marine species;
a predetermined amount of negatively buoyant material selected from a group consisting of sand, grain grit, sediment, sinking pellets, crushed shells, or aquatic plant-based feed sufficient to sink said chum in salt water;
a predetermined amount of bulk enhancer selected from the group consisting of oats, flour, cornmeal, or wheat in an amount sufficient to facilitate uniform mixing and allow gradual dispersal in salt water; and
a predetermined amount of honey to act as a binder for maintaining a sphere shape during freezing and storage, wherein said honey and said bulk enhancer gradually dissolves in water, releasing the chum over a period of time to optimize the chum's effectiveness in attracting marine species.

2. The freezable chum sphere according to claim 1, wherein said chum is selected from the group consisting of sardines, mackerel or anchovies.

3. The freezable chum sphere according to claim 1 including shellfish remains, shrimp heads, or crab shells to add a scent trail.

4. The freezable chum sphere according to claim 1 including an amount of fish blood to create a scent trail.

5. The freezable chum sphere according to claim 1 including an amount of animal offal to create a scent trail.

6. The freezable chum sphere according to claim 1, wherein said negatively buoyant material is defined as sand having a micron rating between 100 and 1000 microns.

7. The freezable chum sphere according to claim 1, wherein said honey is added in an amount to facilitate controlled dispersal of the chum through osmotic diffusion wherein a gradual release of said chum into a surrounding water column.

8. The freezable chum sphere according to claim 1, wherein the chum sphere is constructed and arranged to disperse evenly as the chum sphere descends through a water column wherein fish are attracted to the chum at various depths.

9. The freezable chum sphere according to claim 1 including edible glitter to enhance visual attraction and provide a sparkling effect in the water.

10. The freezable chum sphere according to claim 9, wherein said edible glitter is biodegradable.

11. A freezable chum sphere configured for use in attracting marine species, the chum sphere comprising:
a predetermined amount of chum selected from the group consisting of sardines, mackerel or anchovies;
sand having a micron rating between 100 and 1000 microns in an amount sufficient to sink said chum in salt water;
a predetermined amount of bulk enhancer selected from the group consisting of oats, flour, cornmeal, or wheat in an amount sufficient to facilitate uniform mixing and allow gradual dispersal in salt water; and
a predetermined amount of honey to act as a binder for maintaining a sphere shape during freezing and storage, wherein said honey and said bulk enhancer gradually dissolves in water, releasing the chum over a period of time to optimize the chum's effectiveness in attracting marine species.

12. The freezable chum sphere according to claim 11 including shellfish remains, shrimp heads, or crab shells to add a scent trail.

13. The freezable chum sphere according to claim 11 including an amount of fish blood to create a scent trail.

14. The freezable chum sphere according to claim 11 including an amount of animal offal to create a scent trail.

15. The freezable chum sphere according to claim 11, wherein said honey is added in an amount to facilitate controlled dispersal of the chum through osmotic diffusion wherein a gradual release of said chum into a surrounding water column.

16. The freezable chum sphere according to claim 11, wherein the chum sphere is constructed and arranged to disperse evenly as the chum sphere descends through a water column wherein fish are attracted to the chum at various depths.

17. The freezable chum sphere according to claim 11 including edible glitter to enhance visual attraction and provide a sparkling effect in the water.

18. The freezable chum sphere according to claim 17, wherein said edible glitter is biodegradable.

19. A method of producing a freezable chum sphere for attracting marine species, the method comprising the steps of:
selecting a predetermined amount of chum for use as a primary attractant for marine species selected from the group consisting of ground fish parts, fishmeal, sardines, mackerel or anchovies;
inserting sand in an amount to provide sufficient weight for the chum to sink in saltwater, said sand having a micron rating between 100 and 1000 microns;
inserting a bulk enhancer selected from the group consisting of oats, flour, cornmeal, or wheat to facilitate uniform mixing of said sand and chum and allow gradual dispersal when placed in saltwater;
admixing honey therein forming a homogenous mixture, said honey added in an amount to maintain the integrity of the chum sphere during freezing and storage;
placing said homogeneous mixture into a 3D-printed PETG mold to form a sphere shape;
freezing said mold with said homogenous mixture;
removal of the frozen homogenous mixture and ensure the freezing process preserves the structural integrity and uniform distribution of the ingredients within the spheres;
storing the chum sphere in a supportive structure to preserve the spherical shape of the homogenous mixture; and
deploying the frozen chum spheres into fishing environments, wherein the honey gradually dissolves in water, releasing the attractants to maximize marine species attraction.
